(19) United States
(12) Patent Application Publication
(10) Pub. No.: US 2024/0126530 A1
(43) Pub. Date: Apr. 18, 2024

(54) SOFTWARE COMPLIANCE MANAGEMENT FOR HYBRID ENVIRONMENT

(71) Applicant: International Business Machines Corporation, Armonk, NY (US)

(72) Inventors: Sudheesh S. Kairali, Bangalore (IN); Rambabu Parvatina, Singapore (SG); Venkatesh Krishnan, Singapore (SG); Shanmukha Sai Ram Paran Parvathina, Dublin (IE); Nataraj Nagaratnam, Durham, NC (US)

(21) Appl. No.: 17/967,779

(22) Filed: Oct. 17, 2022

(51) Int. Cl. G06F 8/65

(52) U.S. Cl. CPC G06F 8/65

(57) ABSTRACT

An example operation may include one or more of identifying, via a hybrid environment, components which are included in a software program within the hybrid environment, generating a software bill of materials (SBOM) for the software program which comprises names of the identified components, detecting that the software program does not comply with a predefined policy based on the names of the identified components within the SBOM, and displaying a notification via a user interface based on the detection.

### BACKGROUND

A hybrid environment such as a hybrid cloud is essentially a mix of a private environment (private cloud) which is typically located on-premises, and a public environment (public cloud) that is hosted by a cloud provider. In this architecture, non-critical activities can be performed within the public cloud while critical activities may be performed in the private cloud. Based on benefits from both private and public aspects of the hybrid environment, the customer's infrastructure becomes easier to scale in comparison to private cloud alone, more flexible than private cloud alone, and more secure in comparison to a public cloud alone.

In many cases, cloud providers that offer to host such a hybrid environment will also allow integration with third-party software (3^{rd} party partners). However, the 3^{rd} party partners often have their own compliance and regulatory standards that may not be an exact match with the cloud provider. This mismatch of compliance and regulation can create vulnerabilities and other issues within the hybrid environment. Accordingly, what is needed is a way to manage the security and compliance of a hybrid environment that includes 3^{rd} party software.

### SUMMARY

One example embodiment provides an apparatus that includes a processor configured to one or more of identify, via a hybrid environment, components which are included in a first software program within the hybrid environment, generate a software bill of materials (SBOM) for the first software program based on the identified components, detect that the first software program does not comply with a second software program within with the hybrid environment based on the SBOM, and display a notification via a user interface based on the detection. Some of the benefits of the apparatus is that the apparatus can detect mismatches in compliance among disparate software programs and can notify programmers and developers of the compliance problems via a user interface.

Another example embodiment provides a method that includes one or more of identifying, via a hybrid environment, components which are included in a first software program within the hybrid environment, generating a software bill of materials (SBOM) for the first software program based on the identified components, detecting that the first software program does not comply with a second software program within the hybrid environment based on the SBOM, and displaying a notification via a user interface based on the detection. Some of the benefits provided by the method include improved awareness of the components within the hybrid environment because a SBOM is created of a program within the hybrid environment.

A further example embodiment provides a computer-readable medium comprising instructions, that when read by a processor, cause the processor to perform one or more of identifying, via a hybrid environment, components which are included in a first software program within the hybrid environment, generating a software bill of materials (SBOM) for the first software program based on the identified components, detecting that the first software program does not comply with a second software program within the hybrid environment based on the SBOM, and displaying a notification via a user interface based on the detection. Some of the benefits provided by the medium include improved awareness of the components within the hybrid environment via the SBOM and more accurate detection of mismatches in compliance using such a SBOM.

In some embodiments, the system and method may determine to update the components within the software program based on the detection that the software program does not comply with the predefined policy, and in response, install one or more software updates to the software program within the hybrid environment. Some of the benefits realized by this step include automatically reconciling mismatches in compliance without a need for user involvement.

In some embodiments, the system and method may install an agent within the hybrid environment, and collect the components from the software program within the hybrid environment via the agent. Some of the benefits provided by the agent installation include local access to the hybrid environment which enables the SBOM to be generated. Such access is not typically provided for a cloud provider within a hybrid environment.

In some embodiments, the system and method may receive an update message from the hybrid environment with an update to the components within the software program in the hybrid environment, and in response, modify the SBOM based on the update to the components. Here, the update message may include a differential between the update the components and a most recent update of the components. By only sending a differential, it is not necessary to send the entire list of SBOM components across the network thereby reducing traffic and increasing system productivity.

In some embodiments, the system and method may SBOM include an author name, a supplier name, one or more component names, version information, and one or more component hashes. By adding these details into the SBOM, the software program is tied to its components in a way that each of the participants of the network can easily identify which components are within the SBOM of the software program.

In some embodiments, the system and method may identify requirements of the software program from a file and compare the identified requirements of the software program to the SBOM to detect that the software program does not comply with the predefined policy. Some of the benefits of this step include ensuring the requirements of a third party are met by the cloud provider which is difficult in a hybrid environment.

In some embodiments, the system and method may determine one or more software libraries to install in the hybrid environment based on the detection that the software program does not comply with the predefined policy, and display identifiers of the one or more software libraries via the notification. Furthermore, the one or more software libraries may include a log 4j software library. By automatically installing a log 4j software library into a software program within a hybrid environment, the recent vulnerabilities generated by issues with log 4j errors can be addressed and prevented.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A is a diagram illustrating a cloud computing environment according to an example embodiment.

FIG. 1B is a diagram illustrating a cloud computing environment according to another example embodiment.

FIG. 2A is a diagram illustrating abstraction model layers of a cloud computing environment according to an example embodiment.

FIG. 2B is a diagram illustrating a system for software compliance management in a hybrid environment according to an example embodiment.

FIGS. 3A-3C are diagrams illustrating examples of a permissioned network according to example embodiments.

FIG. 3D is a diagram illustrating machine learning process via a cloud computing platform according to an example embodiment.

FIG. 3E is a diagram illustrating a quantum computing environment associated with a cloud computing platform according to an example embodiment.

FIG. 4A is a diagram illustrating a process of detecting SBOMs from a hybrid environment according to example embodiments.

FIG. 4B is a diagram illustrating a process of detecting a compliance issue based on the SBOMs detected from the hybrid environment according to example embodiments.

FIG. 4C is a diagram illustrating a process of updating controls within the hybrid environment based on the detected compliance issue according to example embodiments.

FIG. 5 is a diagram illustrating a method of managing compliance of software programs within a hybrid environment according to an example embodiment.

FIG. 6 is a diagram illustrating an example of a computing system that supports one or more of the example embodiments.

### DETAILED DESCRIPTION

It is to be understood that although this disclosure includes a detailed description of cloud computing, implementation of the teachings recited herein is not limited to a cloud computing environment. Rather, embodiments of the present invention are capable of being implemented in conjunction with any other type of computing environment now known or later developed.

The use of open source software (OSS) is widespread and includes governments, businesses, and consumers alike in applications such as Mozilla Firefox, Linux, and countless other pieces of valuable software that incorporate OSS in their codebases. One such environment where OSS is prevalent is in a hybrid cloud environment. Many cloud providers offer a package of applications, services, libraries, etc., as part of an initial package that is provided to the hybrid environment their customers). However, the standard cloud package may not have a number of custom applications and other software that is used by the customers. As a result, many customers add their own software to their hybrid cloud environment.

In late 2021, a major vulnerability in a widely used piece of opens source code known as Log 4j created an issue that caused companies and governments alike to scramble to protect the potentially millions of affected devices, making the critical importance of OSS security more evident than ever. One of the main reasons the Log 4J vulnerability was so severe is that many technology providers did not know if and how Log 4J was used throughout their code. As a result of this lack of knowledge, when new, more secure versions were released, or patches to critical vulnerabilities were available, many technology providers failed to identify when and where they needed to take action. The Log 4j issue serves as a case study for policymakers interested in bolstering OSS security and software security as a whole. It highlights the problems that can arise in software supply chain management and requires a valuable new approach to help combat these challenges.

In the example embodiments, a novel solution is provided which can prevent Log 4j type of issues from occurring within hybrid cloud environments based on a software bill of materials (SBOM). An SBOM is a formal record of all the components needed to build a particular piece of software and the supply chain relationships of these components. Technology providers may not be aware of where and how components such as OSS code (and other 3^{rd} party code) are used throughout their codebase, making identifying and responding to security threats cumbersome and unreliable. However, SBOMs can relieve this burden. In particular, SBOMs provide better visibility into the software supply chain of modern application development.

Within the cloud environment may be a central host service, referred to herein as a security and compliance center (SCC). The host service may install an agent program within a hybrid environment for monitoring/scanning the hybrid environment for software to be included in a bill of materials. The agent may be configured to collect information of the software within the hybrid environment and feed this information back to the host service. The host service may use this collected information to generate one or more SBOMs. As an example, each software program, library, package, application, etc., may have its own SBOM created for it. The SBOMs may include details about the software and it's OSS and third-party components that are combined to make the software including an author, a supplier, component name(s), a version string, a component hash, a unique identifier, relationship information, and the like, of each of the components. The components within the SBOM may include open software and third-party software products such as methods, programs, code modules, libraries, application programming interfaces, and the like.

The host service may include a database with a list of controls (referred to herein as components) for each of the software programs currently running in the hybrid environment. These controls may include libraries, software packages, version information, third-party data, third-party software, and the like, which the software needs to run properly. The host service may compare the controls to the version of the software running within the hybrid environment to determine whether any of the software is missing the necessary controls. Should the controls be missing, the host service can automatically identify and install any missing controls through the form of software updates, patches, installation of applications or other programs, upgrading (or downgrading) versions of the software, and the like. Examples of the missing controls, or components, which may be added to a software program within the hybrid environment include missing open source software and third-party software such as software libraries, patches, different versions, etc. The missing controls may also include missing security such as a missing TLS protection on a communication channel between the software program and an external database. In this case, the host process can update the software to ensure that the communications are TLS protected.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Examples of cloud computing characteristics that may be associated with the example embodiments include the following.
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Examples of service models that may be associated with the example embodiments include the following:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Examples of deployment models that may be associated with the example embodiments include the following:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

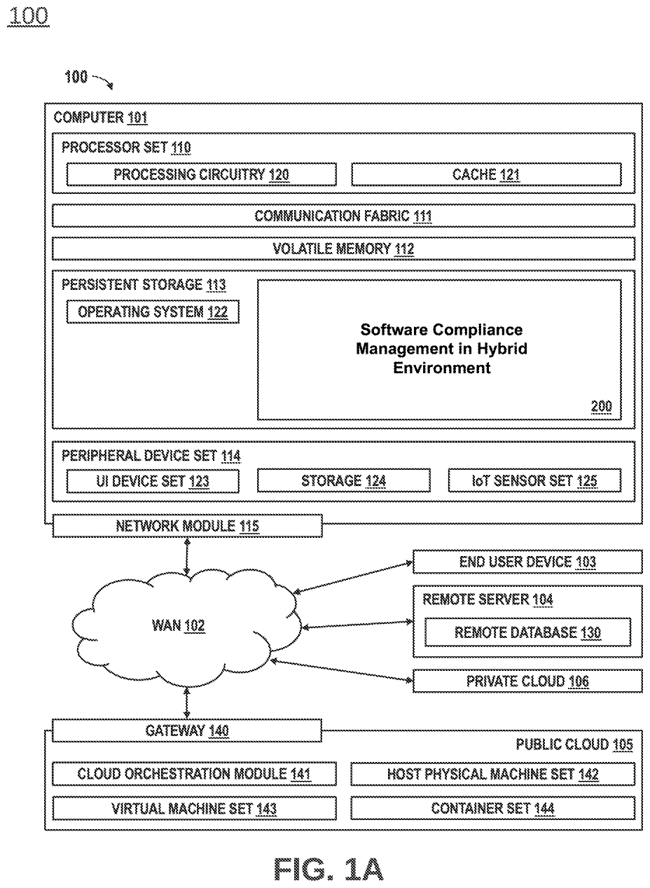

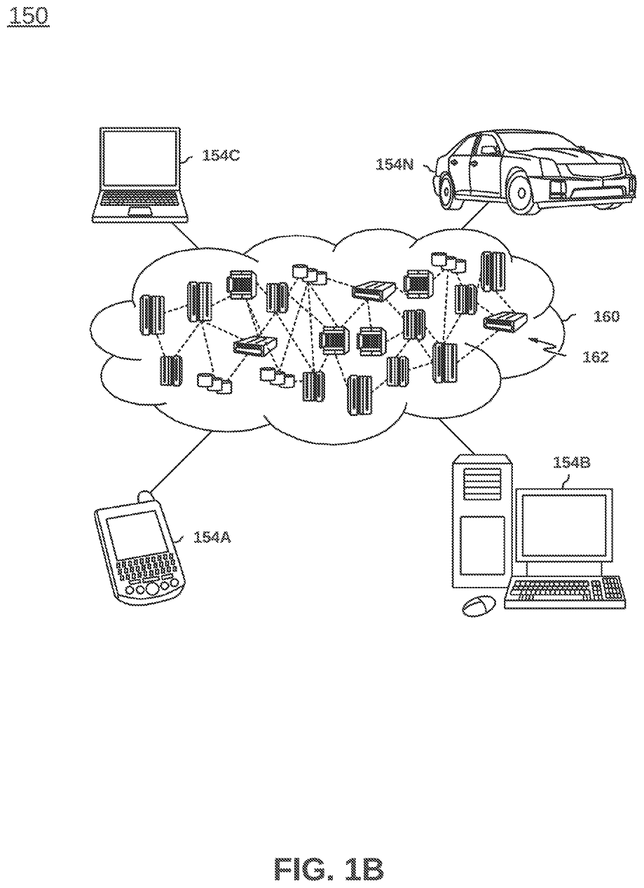

Referring now to FIG. 1A, a computing environment 100 is depicted. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for executing at least some of the computer code involved in performing the inventive methods, such as software compliance management in a hybrid environment as shown in block 200. In addition to block 200, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation of the computing environment 100, a detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication Fabric 111 is the signal conduction paths that allow the various components of computer 101 to communicate with each other. Typically, this fabric comprises switches and electrically conductive paths, such as the switches and electrically conductive paths that make up busses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, this data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as communicating with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

Referring now to FIG. 1B, an illustrative cloud environment 150 is depicted. As shown, cloud computing environment 160 includes one or more cloud computing nodes 162 with which local computing devices used by cloud consumers, such as, for example, personal digital assistant (PDA) or cellular telephone 154A, desktop computer 154B, laptop computer 154C, and/or automobile computer system 154N may communicate. Nodes 162 may communicate with one another. They may be grouped (not shown) physically or virtually in one or more networks, such as Private, Community, Public, or Hybrid clouds as described hereinabove, or a combination thereof. This allows cloud computing environment 160 to offer infrastructure, platforms and/or software as services for which a cloud consumer does not need to maintain resources on a local computing device. It is understood that the types of computing devices 154A-N shown in FIG. 1B are intended to be illustrative only and that computing nodes 162 and cloud computing environment 160 can communicate with any type of computerized device over any type of network and/or network addressable connection (e.g., using a web browser).

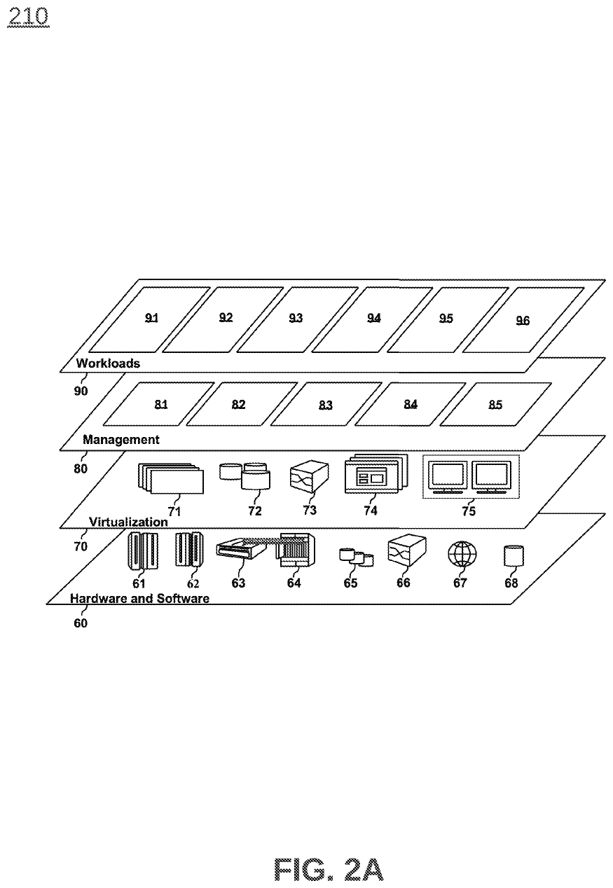

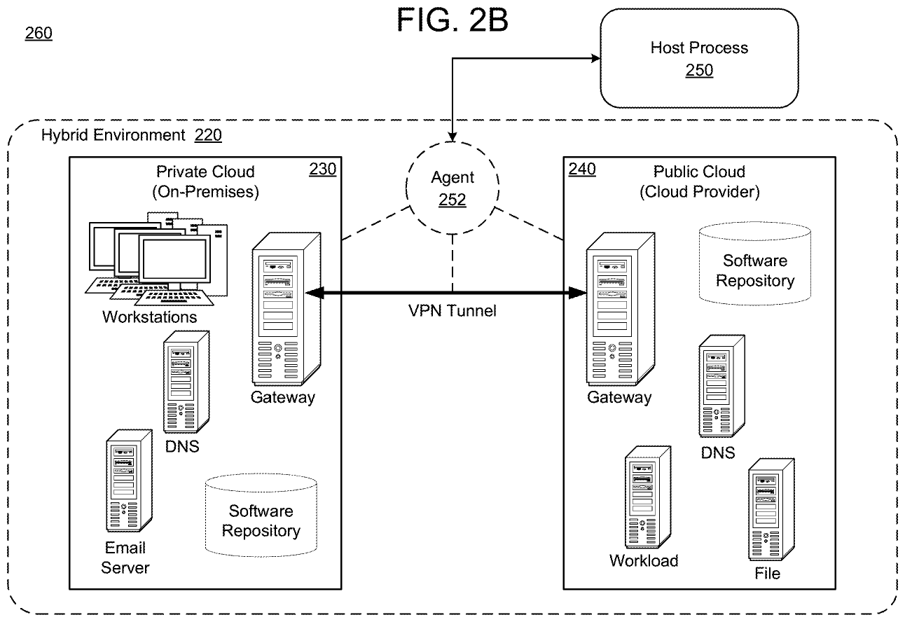

Referring now to FIG. 2A, a set 210 of functional abstraction layers provided by cloud computing environment 50 FIG. 1) is shown. It should be understood in advance that the components, layers, and functions shown in FIG. 2A are intended to be illustrative only and embodiments of the invention are not limited thereto. As depicted, the following layers and corresponding functions are provided within the set 210: Hardware and software layer 60 include hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68. Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below.

Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workload layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and software compliance management in a hybrid environment processing 96.

A supply chain in a traditional sense is a network between a company and its suppliers to produce and distribute a specific product or service. The entities in the supply chain include producers, vendors, warehouses, transportation companies, distribution centers, and retailers. The supply chain may include all entities necessary to deliver a product to a customer. Likewise, a “software” supply chain may include all entities affecting a software product from development of the code to deployment including any continuous integration and continuous development (CI/CD) steps performed to deliver the software. The scope of the software supply chain becomes wider in case of partnerships.

For example, a cloud provider may partner with various third-party vendors to provide a suite of software to hybrid cloud customers. In many cases, the cloud provider offers a number of software programs in default and the third-party vendors offer “complimentary” applications and services which can also be used in the hybrid environment. In such a scenario, security and compliance are two of the more important goals for most customers. Even though two software platforms can partner each other, their compliance and regulatory standards may be very different, and it could affect customers adoptability of overall solution. Therefore, cloud providers must take steps to ensure that the components of the third-party software that they are providing complies with its requirements including any additional layers of protection such as encryption, cryptography, software libraries, patches, and the like.

The example embodiments are directed to a system that can monitor a hybrid environment and identify the software programs (e.g., applications, services, libraries, packages, etc.) currently running within the hybrid environment as well as the components of the software programs. The components may include open source software, third party software, and other components which make up the software program. For example, an agent may be installed within the hybrid environment and may scan the software programs and/or files to identify the components required for each of the software programs. The agent may feed this information to a central host service, referred to herein as the security and compliance center (SCC). The SCC may construct a software bill of materials (SBOM) for each of the software programs in the hybrid environment. Furthermore, the SCC may compare the SBOMs of each of the software programs to predefined policies and other requirements associated with the software programs to ensure that each software program is running its correct components including libraries, data, cryptography, encryption, network security, and the like. Furthermore, if a software program is not fully in compliance with is required components, the central service may identify a software update and install the software update to the software program running in the hybrid environment via the agent. For example, the central service may identify a missing open source software component and install it within the software program in the hybrid environment. As another example, the central service may detect an incorrect version of a piece of code within the software program, and install the correct version.

FIG. 2B illustrates a system 260 for software compliance management in a hybrid environment. For example, the system may perform the software compliance management in a hybrid environment processing 96 shown in FIG. 2A. Referring to FIG. 2B, the system 260 includes a hybrid environment 220 and a host process 250 such as the SCC within a cloud platform environment. The hybrid environment 220 may include a combination of private cloud 230 and public cloud 240 which are connected to each other via a private network/channel such as a virtual private network (VPN). The private cloud 230 may be an on-premises system that includes the components that the customer wishes to remain private such as email, workstations, certain software, and the like. Meanwhile, the public cloud 240 is publicly available and is hosted by a cloud provider. The public cloud 240 may include other aspects of the hybrid environment 220 that are fine to be available publicly such as workloads, user interfaces, file servers/access, and the like.

According to various embodiments, the host process 250 may install an agent 252 within the hybrid environment 220. The agent 252 may include a software program capable of scanning both the private cloud 230 and the public cloud 240 to identify the software programs running therein as well as the components that are included in each of the software components. The agent 252 may feed information identifying the software programs and the components currently included in the software components and send them to the host process 250. The host process 250 may use the data collected from the agent 252 to build SBOMs for each of the programs in the hybrid environment 220 including applications, services, software packages, and the like. As an example, the agent 252 may access containers within the hybrid environment which contain the software programs and identify the components from the containers. As another example, one container in the hybrid environment may include the components of all of the software programs therein, but embodiments are not limited thereto.

The host process 250 may also have access to requirements of the software programs which may be provided during a registration process with the cloud provider. As another example, the host process 250 may have access to the components installed within other software programs as well as how the lack of compliance was handled in those cases, and use that information to make recommendations on how to bring the components of the software program into compliance. For example, the host process 250 may detect that a software application is running inside the hybrid environment 220 without one if its required libraries. In this case, the host process 250 may generate a software update including the required library, and deliver the software update to the agent 252 installed within the hybrid environment 220.

Next, the agent 252 may remedy the lack of compliance and install the software update within the software application thereby integrating the required library (which was missing) into the software application. As another example, the host process 250 may detect that a service running in the hybrid environment requires a transport layer security (TLS) protocol when communicating with an external data source (another third party). In this case, the host process may install a software patch or update to integrate the TLS protection into the communications with the external data store. It should also be appreciated that the central process 250 and the agent 252 can detect many kinds of missing components and install them or remediate issues that are created by the missing components.

As previously noted, the host process 250 may be a security and compliance center. A security and compliance center may include components such as posture management and configuration governance that are directly integrated with the platform and designed to help achieve a continuously secure and compliant development environment in different ways. For example, the SCC can work with predefined controls that are implemented across cloud customers, define configuration rules and templates that prevent unsecure configuration of cloud resources, monitor resource configurations in a single dashboard for any potential risk, investigate the evaluation results to see which accounts or services are most at risk, retain and access results to prepare for internal and external audits, and the like.

In some embodiments, the SCC may be modified to include an additional layer of capability to get the details of SBOM from the software programs deployed within the hybrid environment. The SBOM includes a list of entities, components, libraries of software of a target, etc. Based on the BOM the SCC will be able to detect the controls required for the target. The controls will be additional to what user might have selected already. Accordingly, the SCC can recommend SBOM based controls. Furthermore, the customer/user might have ability to override this as part of the default controls.

In some embodiments, the SCC may collect data from the agent in the form of “differentials”. Each time an update or other change is detected within the hybrid environment, the agent may collect data of the update and send it to the SCC. The “differential” may be a message which identifies just the components of the software program that were updated and not all components. Any changes in the SBOM will be sent to the SCC. Furthermore, the system may also generate plugins to handle custom BOMs and a model to handle heterogenous scenarios and very specific target environments. During the feedback process, the SCC and the agent may perform a “handshake” that involves some form of authentication between the SCC and the agent such as a key, credential, etc. The handshake between SCC and the agent may include a new control message with the differential changes to a SBOM and the SCC will respond back with adjustments to the controls of the software corresponding to the SBOM. The new controls may be instantaneously applied on the target hybrid environment.

When the SCC is running with lot of target environments, the SCC may quickly select the controls required by finding the set of controls that were returned earlier for similar SBOMs. The SCC may have a default list of SBOM entries expected and required controls. This list will be updated by the cloud provider. This will be based on ongoing security issues as well as capabilities. Customer can also provide a list. Customer may also override the cloud provider provided list or mark exceptions

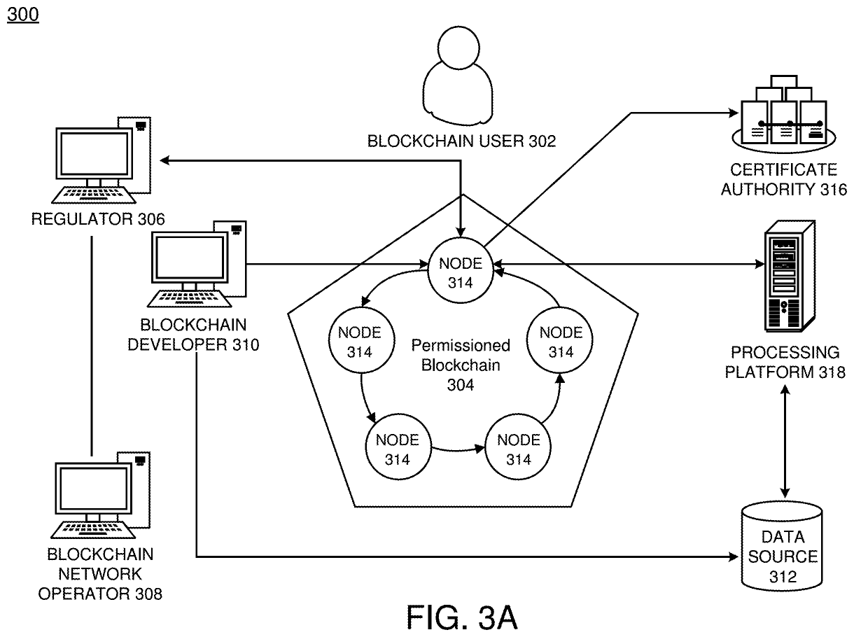

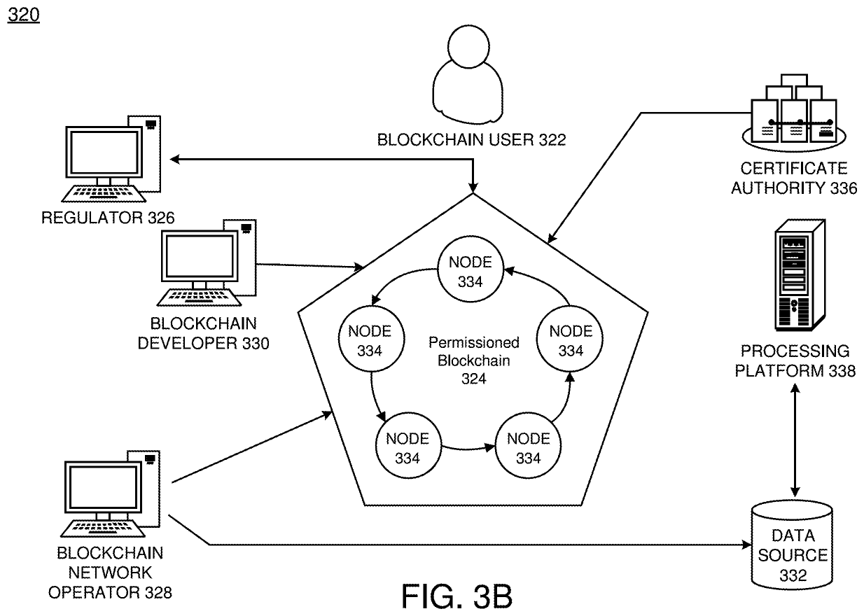

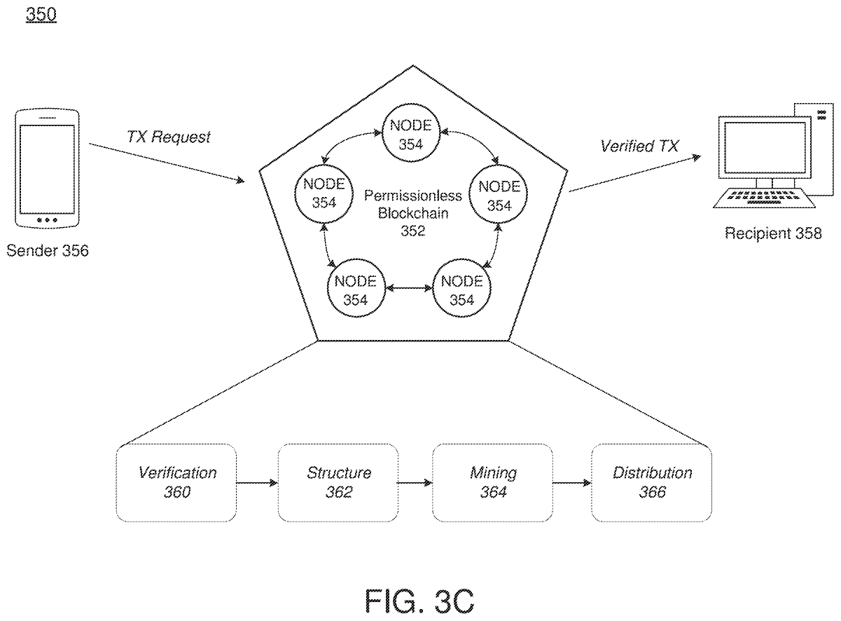

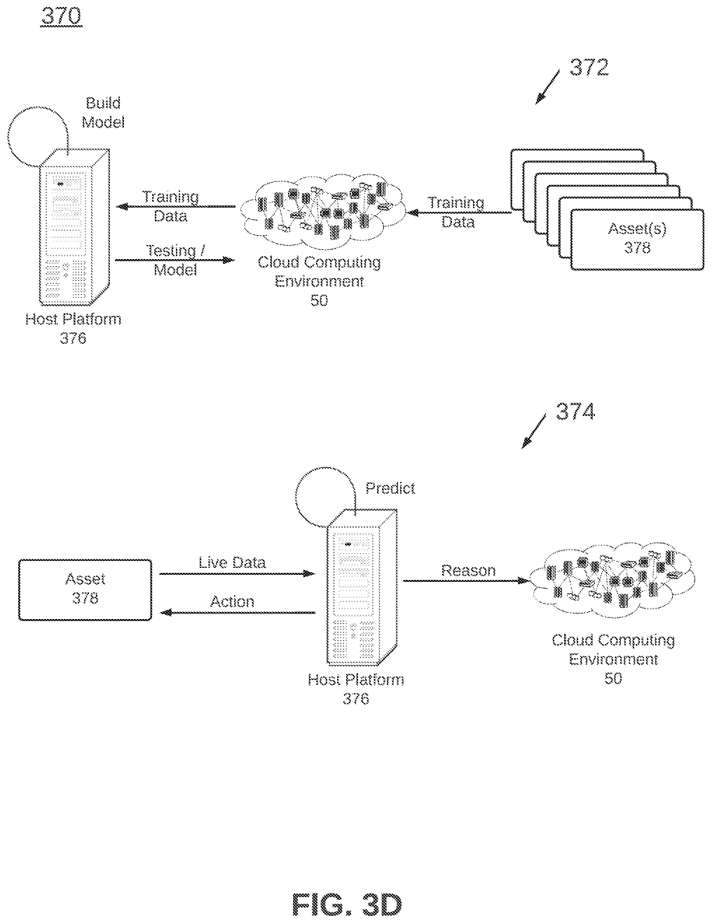

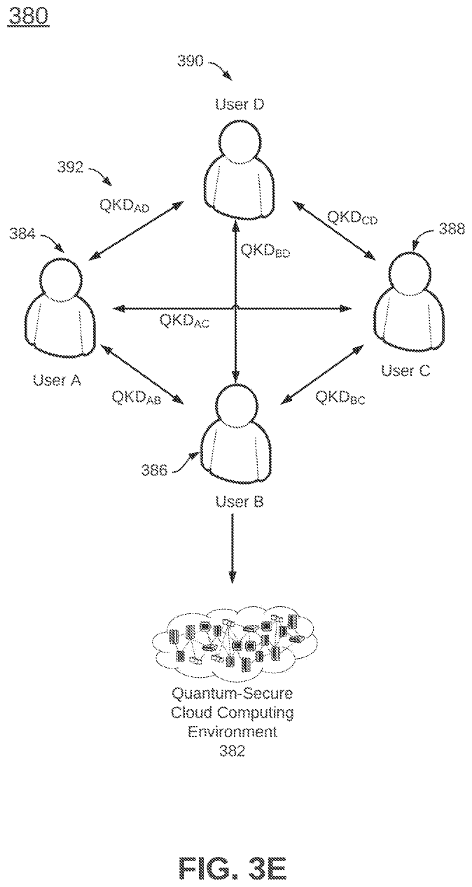

FIGS. 3A-3E provide various examples of additional features that may be used in association with the cloud computing environment described herein. These examples should be considered as additional extensions or additional examples of the embodiments described herein.

FIG. 3A illustrates an example of a permissioned blockchain network 300, which features a distributed, decentralized peer-to-peer architecture. The blockchain network may interact with the cloud computing environment 50, allowing additional functionality such as peer-to-peer authentication for data written to a distributed ledger. In this example, a blockchain user 302 may initiate a transaction to the permissioned blockchain 304. In this example, the transaction can be a deploy, invoke, or query, and may be issued through a client-side application leveraging an SDK, directly through an API, etc. Networks may provide access to a regulator 306, such as an auditor. A blockchain network operator 308 manages member permissions, such as enrolling the regulator 306 as an “auditor” and the blockchain user 302 as a “client”. An auditor could be restricted only to querying the ledger whereas a client could be authorized to deploy, invoke, and query certain types of chaincode.

A blockchain developer 310 can write chaincode and client-side applications. The blockchain developer 310 can deploy chaincode directly to the network through an interface. To include credentials from a traditional data source 312 in chaincode, the developer 310 could use an out-of-band connection to access the data. In this example, the blockchain user 302 connects to the permissioned blockchain 304 through a peer node 314. Before proceeding with any transactions, the peer node 314 retrieves the user's enrollment and transaction certificates from a certificate authority 316, which manages user roles and permissions. In some cases, blockchain users must possess these digital certificates in order to transact on the permissioned blockchain 304. Meanwhile, a user attempting to utilize chaincode may be required to verify their credentials on the traditional data source 312. To confirm the user's authorization, chaincode can use an out-of-band connection to this data through a traditional processing platform 318.

FIG. 3B illustrates another example of a permissioned blockchain network 320, which features a distributed, decentralized peer-to-peer architecture. In this example, a blockchain user 322 may submit a transaction to the permissioned blockchain 324. In this example, the transaction can be a deploy, invoke, or query, and may be issued through a client-side application leveraging an SDK, directly through an API, etc. Networks may provide access to a regulator 326, such as an auditor. A blockchain network operator 328 manages member permissions, such as enrolling the regulator 326 as an “auditor” and the blockchain user 322 as a “client”. An auditor could be restricted only to querying the ledger whereas a client could be authorized to deploy, invoke, and query certain types of chaincode.

A blockchain developer 330 writes chaincode and client-side applications. The blockchain developer 330 can deploy chaincode directly to the network through an interface. To include credentials from a traditional data source 332 in chaincode, the developer 330 could use an out-of-band connection to access the data. In this example, the blockchain user 322 connects to the network through a peer node 334. Before proceeding with any transactions, the peer node 334 retrieves the user's enrollment and transaction certificates from the certificate authority 336. In some cases, blockchain users must possess these digital certificates in order to transact on the permissioned blockchain 324. Meanwhile, a user attempting to utilize chaincode may be required to verify their credentials on the traditional data source 332. To confirm the user's authorization, chaincode can use an out-of-band connection to this data through a traditional processing platform 338.

In some embodiments, the blockchain herein may be a permissionless blockchain. In contrast with permissioned blockchains which require permission to join, anyone can join a permissionless blockchain. For example, to join a permissionless blockchain a user may create a personal address and begin interacting with the network, by submitting transactions, and hence adding entries to the ledger. Additionally, all parties have the choice of running a node on the system and employing the mining protocols to help verify transactions.

FIG. 3C illustrates a process 350 of a transaction being processed by a permissionless blockchain 352 including a plurality of nodes 354. A sender 356 desires to send payment or some other form of value (e.g., a deed, medical records, a contract, a good, a service, or any other asset that can be encapsulated in a digital record) to a recipient 358 via the permissionless blockchain 352. In one embodiment, each of the sender device 356 and the recipient device 358 may have digital wallets (associated with the blockchain 352) that provide user interface controls and a display of transaction parameters. In response, the transaction is broadcast throughout the blockchain 352 to the nodes 354. Depending on the blockchain's 352 network parameters the nodes verify 360 the transaction based on rules (which may be pre-defined or dynamically allocated) established by the permissionless blockchain 352 creators. For example, this may include verifying identities of the parties involved, etc. The transaction may be verified immediately or it may be placed in a queue with other transactions and the nodes 354 determine if the transactions are valid based on a set of network rules.

In structure 362, valid transactions are formed into a block and sealed with a lock (hash). This process may be performed by mining nodes among the nodes 354. Mining nodes may utilize additional software specifically for mining and creating blocks for the permissionless blockchain 352. Each block may be identified by a hash (e.g., 256 bit number, etc.) created using an algorithm agreed upon by the network. Each block may include a header, a pointer or reference to a hash of a previous block's header in the chain, and a group of valid transactions. The reference to the previous block's hash is associated with the creation of the secure independent chain of blocks.

Before blocks can be added to the blockchain, the blocks must be validated. Validation for the permissionless blockchain 352 may include a proof-of-work (PoW) which is a solution to a puzzle derived from the block's header. Although not shown in the example of FIG. 3C, another process for validating a block is proof-of-stake. Unlike the proof-of-work, where the algorithm rewards miners who solve mathematical problems, with the proof of stake, a creator of a new block is chosen in a deterministic way, depending on its wealth, also defined as “stake.” Then, a similar proof is performed by the selected/chosen node.

With mining 364, nodes try to solve the block by making incremental changes to one variable until the solution satisfies a network-wide target. This creates the PoW thereby ensuring correct answers. In other words, a potential solution must prove that computing resources were drained in solving the problem. In some types of permissionless blockchains, miners may be rewarded with value (e.g., coins, etc.) for correctly mining a block.

Here, the PoW process, alongside the chaining of blocks, makes modifications of the blockchain extremely difficult, as an attacker must modify all subsequent blocks in order for the modifications of one block to be accepted. Furthermore, as new blocks are mined, the difficulty of modifying a block increases, and the number of subsequent blocks increases. With distribution, the successfully validated block is distributed through the permissionless blockchain 352 and all nodes 354 add the block to a majority chain which is the permissionless blockchain's 352 auditable ledger. Furthermore, the value in the transaction submitted by the sender 356 is deposited or otherwise transferred to the digital wallet of the recipient device 358.

FIGS. 3D and 3E illustrate additional examples of use cases for cloud computing that may be incorporated and used herein. FIG. 3D illustrates an example 370 of a cloud computing environment 50 which stores machine learning (artificial intelligence) data. Machine learning relies on vast quantities of historical data (or training data) to build predictive models for accurate prediction on new data. Machine learning software (e.g., neural networks, etc.) can often sift through millions of records to unearth non-intuitive patterns.

In the example of FIG. 3D, a host platform 376 builds and deploys a machine learning model for predictive monitoring of assets 378. Here, the host platform 366 may be a cloud platform, an industrial server, a web server, a personal computer, a user device, and the like. Assets 378 can be any type of asset (e.g., machine or equipment, etc.) such as an aircraft, locomotive, turbine, medical machinery and equipment, oil and gas equipment, boats, ships, vehicles, and the like. As another example, assets 378 may be non-tangible assets such as stocks, currency, digital coins, insurance, or the like.

The cloud computing environment 50 can be used to significantly improve both a training process 372 of the machine learning model and a predictive process 374 based on a trained machine learning model. For example, in 372, rather than requiring a data scientist/engineer or another user to collect the data, historical data may be stored by the assets 378 themselves (or through an intermediary, not shown) on the cloud computing environment 50. This can significantly reduce the collection time needed by the host platform 376 when performing predictive model training. For example, data can be directly and reliably transferred straight from its place of origin to the cloud computing environment 50. By using the cloud computing environment 50 to ensure the security and ownership of the collected data, smart contracts may directly send the data from the assets to the individuals that use the data for building a machine learning model. This allows for sharing of data among the assets 378.

Furthermore, training of the machine learning model on the collected data may take rounds of refinement and testing by the host platform 376. Each round may be based on additional data or data that was not previously considered to help expand the knowledge of the machine learning model. In 372, the different training and testing steps (and the data associated therewith) may be stored on the cloud computing environment 50 by the host platform 376. Each refinement of the machine learning model (e.g., changes in variables, weights, etc.) may be stored in the cloud computing environment 50 to provide verifiable proof of how the model was trained and what data was used to train the model. For example, the machine learning model may be stored on a blockchain to provide verifiable proof. Furthermore, when the host platform 376 has achieved a trained model, the resulting model may be stored on the cloud computing environment 50.

After the model has been trained, it may be deployed to a live environment where it can make predictions/decisions based on the execution of the final trained machine learning model. For example, in 374, the machine learning model may be used for condition-based maintenance (CBM) for an asset such as an aircraft, a wind turbine, a healthcare machine, and the like. In this example, data fed back from asset 378 may be input into the machine learning model and used to make event predictions such as failure events, error codes, and the like. Determinations made by the execution of the machine learning model at the host platform 376 may be stored on the cloud computing environment 50 to provide auditable/verifiable proof. As one non-limiting example, the machine learning model may predict a future breakdown/failure to a part of the asset 378 and create an alert or a notification to replace the part. The data behind this decision may be stored by the host platform 376 and/or on the cloud computing environment 50. In one embodiment the features and/or the actions described and/or depicted herein can occur on or with respect to the cloud computing environment 50.

FIG. 3E illustrates an example 380 of a quantum-secure cloud computing environment 382, which implements quantum key distribution (QKD) to protect against a quantum computing attack. In this example, cloud computing users can verify each other's identities using QKD. This sends information using quantum particles such as photons, which cannot be copied by an eavesdropper without destroying them. In this way, a sender, and a receiver through the cloud computing environment can be sure of each other's identity.

In the example of FIG. 3E, four users are present 384, 386, 388, and 390. Each pair of users may share a secret key 392 (i.e., a QKD) between themselves. Since there are four nodes in this example, six pairs of nodes exist, and therefore six different secret keys 392 are used including QKD_{AB}, QKD_{AC}, QKD_{AD}, QKD_{BC}, QKD_{BD}, and QKD_{CD}. Each pair can create a QKD by sending information using quantum particles such as photons, which cannot be copied by an eavesdropper without destroying them. In this way, a pair of users can be sure of each other's identity.

The operation of the cloud computing environment 382 is based on two procedures (i) creation of transactions, and (ii) construction of blocks that aggregate the new transactions. New transactions may be created similar to a traditional network, such as a blockchain network. Each transaction may contain information about a sender, a receiver, a time of creation, an amount (or value) to be transferred, a list of reference transactions that justifies the sender has funds for the operation, and the like. This transaction record is then sent to all other nodes where it is entered into a pool of unconfirmed transactions. Here, two parties (i.e., a pair of users from among 384-390) authenticate the transaction by providing their shared secret key 392 (QKD). This quantum signature can be attached to every transaction making it exceedingly difficult to be tampered with. Each node checks its entries with respect to a local copy of the cloud computing environment 382 to verify that each transaction has sufficient funds.

Conventional methods for training a time-series forecasting model involve three data subsets including a training subset, a validation subset, and a test subset. The training process involves iteratively executing the time-series forecasting model on the training subset until the model reaches a point where it can be validated. The training tries to optimize the parameters of the model (e.g., weights of a neural network, etc.) Meanwhile, hyperparameter optimization, also referred to herein as HPO, attempts to find a suitable set of hyperparameters that are generally not optimized during training.

Hyperparameters refer to configurations that are external to the machine-learning algorithm and have a value that cannot be estimated from the data (e.g., a number of hidden layer within a neural network, learning rate of a neural network, C and sigma parameters in support vector machines, the value of “k” in k-nearest neighbors algorithm, etc.) Conventional hyperparameter optimization for hierarchical time series forecaster training involves choosing a held-out validation time period from the data where the trained model's performance is evaluated and by optimizing that validation performance the hyperparameters of the model are selected. However, this process uses only the lowest-level of time-series for training and does not consider how upper-level time-series may affect the model. Meanwhile, in the example embodiments, a teacher model that is trained on upper-level time-series data may be used to optimize/modify the hyperparameters of a student model which is trained on the lowest-level time-series data.

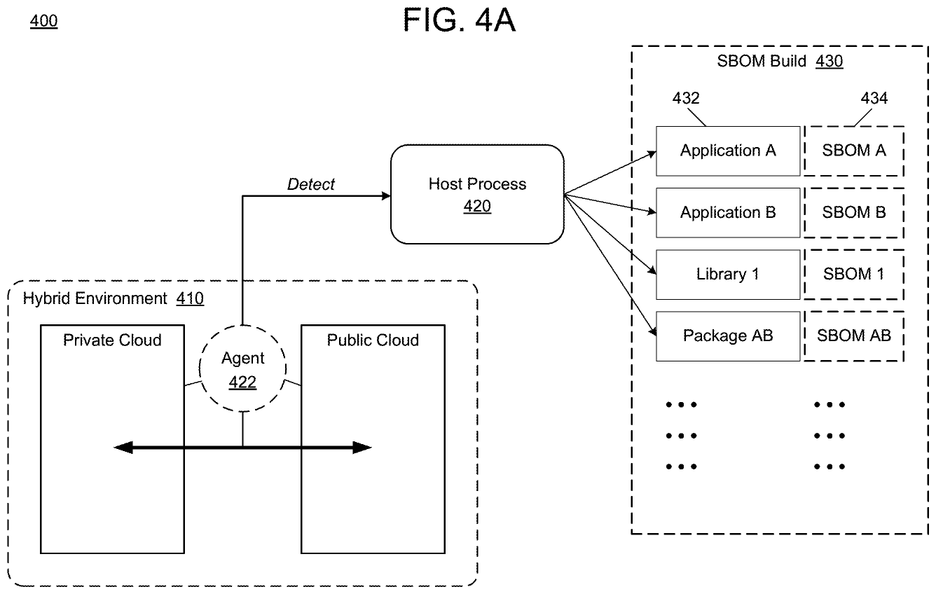

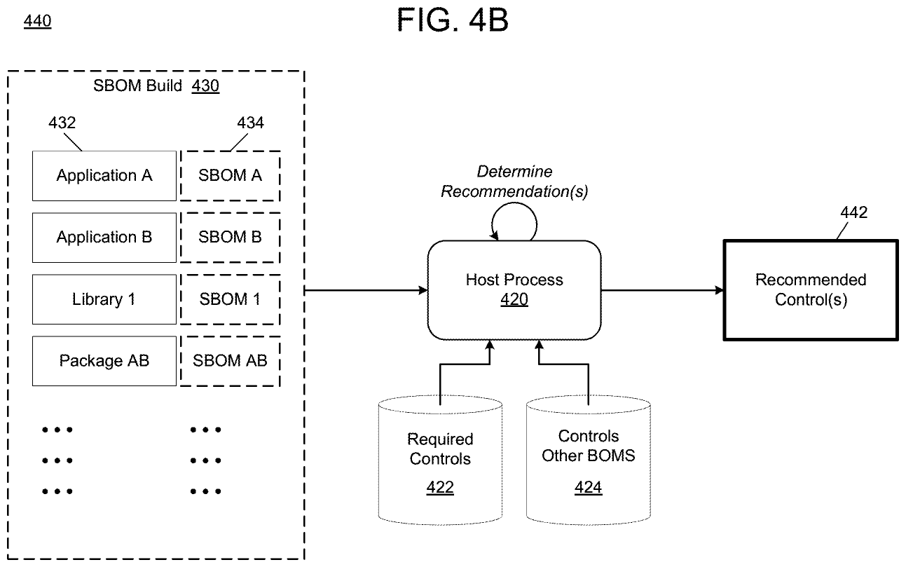

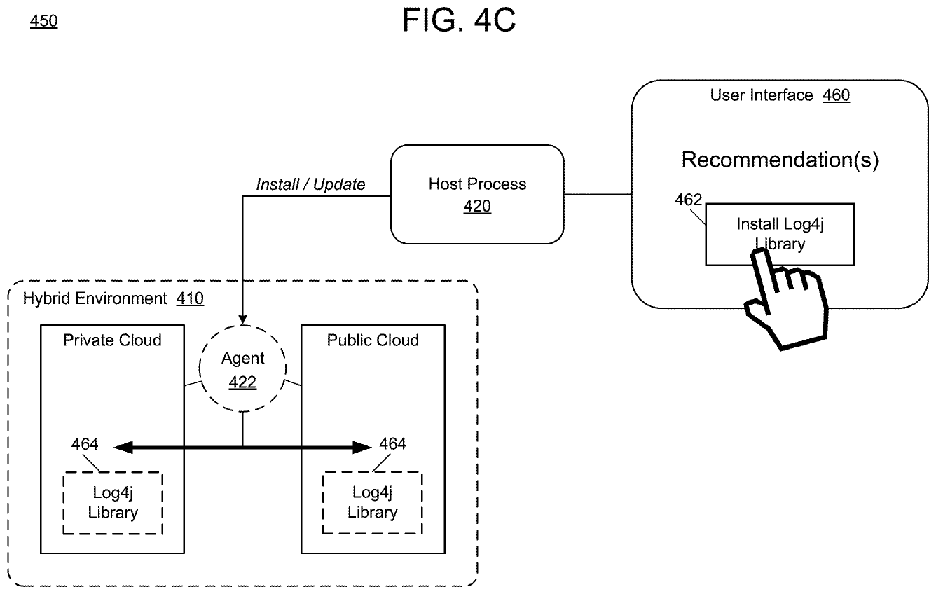

FIG. 4A illustrates a process 400 of detecting SBOMs from a hybrid environment according to example embodiments. According to various embodiments, an agent 422 may be installed within a hybrid environment 410 and collect data about the software running within the hybrid environment 410. The agent 422 may include multiple operating modes including a “detect” mode which is shown in FIG. 4A, and a “remedy” mode which is shown in FIG. 4C. In the example of FIG. 4A, the agent 422 may identify the software within the hybrid environment 410 by name, and also the components (e.g., libraries, etc.) which are currently included with the software. The collected details may be fed back to a host process 420 which may be located external to the hybrid environment 410. As an example, the host process 420 may be provided by the cloud provider of the hybrid environment 410. In response, the host process 420 may build a list of SBOMs 430 based on the details of the software which are fed back to the host process 420 by the agent 422. The list of SBOMs 430 may include an identifier 432 (e.g., a name, etc.) of each software program as well as an SBOM 434 with a list of the components (e.g., the names, versions, authors, suppliers, etc.) including OSS components and third-party components such as code modules, methods, libraries, and the like.

Once agent 422 is installed, it may begin a background task to periodically check the SBOM of the target environment. The SBOM may include a single SBOM with components of all the software therein or individual SBOMs (e.g., one for each software program in the hybrid environment, etc.) The SBOM may be detected in various ways. For example, the SBOM details may be detected from packages which are installed in containers deployed within the hybrid environment. This may require privileges for the agent 422 to execute into various containers. The agent 422 may only detect a list from a container during its uptime. Furthermore, the agent 422 can repeat this detection process if there is an upgrade to the software within the container. As another example, the agent 422 may keep this list with it. As another example, the agent 422 may use known techniques such as OWASP to identify the components within a software program. The agent 422 may be extended with custom plugins so that it can detect very specific software components. As another example, the software pipeline where the software is developed could provide an SBOM that agent can download and aggregate.

In each BOM detection cycle, the agent 422 may keep checking the list and it will have its master list for each of these containers. Except for the first time, a differential list of SBOM details may be sent to the SCC upon an update rather than the entire list of details. For example, if only the version of a software program changes, the new version may be sent back by the agent 422 to the host process 420 without providing other details that have not changed such as the author, supplier, etc.

FIG. 4B illustrates a process 440 of detecting a compliance issue based on the SBOMs detected from the hybrid environment according to example embodiments, and FIG. 4C illustrates a process 450 of updating controls within the hybrid environment based on the detected compliance issue according to example embodiments.

Referring to FIG. 4B, the host process 420 (e.g., the SCC, etc.) may compare the generated list 430 of SBOMs for the software programs to a list of controls that are required for each of the software programs. If a control of a software program is detected as missing or is incorrect based on an SBOM of the software program in comparison to its required controls, the host process 420 may determine which controls need to be installed in the software program within the hybrid environment from the required controls stored in the database 422. The controls may include open source software, third-party software, and the like. The requirements may be provided during an onboarding process of the software with the host platform. In some embodiments, when a lack of compliance is detected (e.g., an SBOM indicates the software is missing a required control, etc.) by the host process 420 may also compare the list 430 of SBOMs for the software programs to a list of similar SBOMs to see how problems were addressed stored in another database 424. This can provide the host process with suggestions for fixing problems for which solutions are not readily identifiable.

Referring now to FIG. 4C, upon detecting the recommended controls 442 to be installed in the software program, the host process 420 may display a notification to a user interface 460. As an example, the host process 420 may display the notification to a developer, owner, or the like, of the software program with a request to install the missing controls 462 which in this example is a missing software library. The user may select to install the missing controls via the user interface 460. For example, the user may select a button, menu, icon, radio button, etc. and make a selection. In response, the host process 420 may trigger the agent 422 to operate in remedy mode. Here, the host process 420 may generate a software update 464 with the missing component (e.g., an open source library in this example, etc.) and deliver the software update to the agent 422 installed within the hybrid environment 410. In response, the agent 422 may install the software update 464 the hybrid environment such as within one or more of the private cloud and the public cloud of the hybrid environment.

As another example, the host process 420 may automatically install the software update 464 without asking or notifying the user who controls the software program. For example, the software programs may agree to be monitored and upgraded to ensure compliance on the platform. Thus, the host process can automatically reconcile any compliance issues for software programs within the hybrid environment. In particular, the host process can ensure that the third-party software and the open source software components within a software program are compliant.

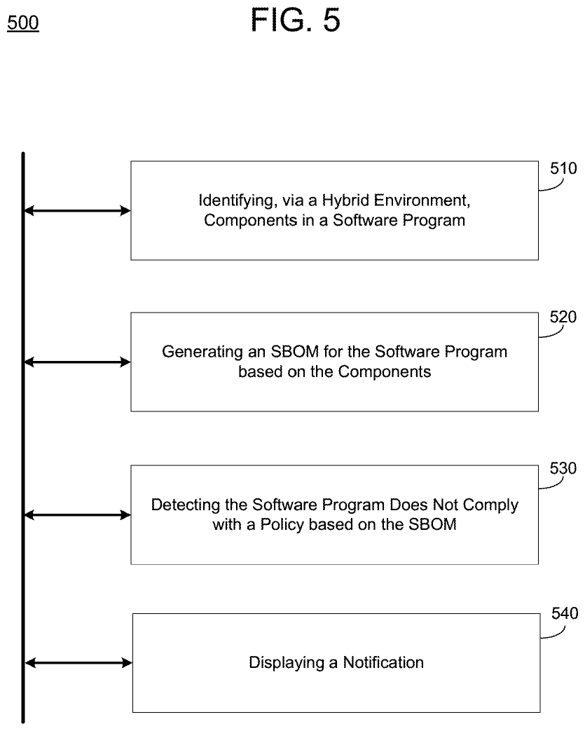

FIG. 5 illustrates a method 500 of managing compliance of software programs within a hybrid environment according to an example embodiment. For example, the method 500 may be performed by a computer system such as a cloud platform, a web server, a personal computer or other user device, and the like. Referring to FIG. 5, in 510 the method may include identifying, via a hybrid environment, components which are included in a software program within the hybrid environment. The components may include libraries, packages, applications, services, data, and the like

In 520, the method may include generating a software bill of materials (SBOM) for the software program which comprises names of the identified components. In 530, the method may include detecting that the software program does not comply with a predefined policy based on the names of the identified components within the SBOM. In 540, the method may include displaying a notification via a user interface based on the detection. In some embodiments, the method may further include determining to update the components within the software program based on the detection that the software program does not comply with the predefined policy, and in response, installing one or more software updates to the software program within the hybrid environment.

In some embodiments, the method may further include installing an agent within the hybrid environment, and collecting the components from the software program within the hybrid environment via the agent. In some embodiments, the method may further include receiving an update message from the hybrid environment with an update to the components within the software program in the hybrid environment, and in response, modifying the SBOM based on the update to the components. In some embodiments, the update message may include a differential between the update the components and a most recent update of the components.

In some embodiments, the SBOM may include an author name, a supplier name, one or more component names, version information, and one or more component hashes. In some embodiments, the detecting may further include identifying requirements of the software program from a file and comparing the identified requirements of the software program to the SBOM to detect that the software program does not comply with the predefined policy. In some embodiments, the method may further include determining one or more software libraries to install in the hybrid environment based on the detection that the software program does not comply with the predefined policy, and displaying identifiers of the one or more software libraries via the notification. In some embodiments, the one or more software libraries comprise a log 4j software library.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

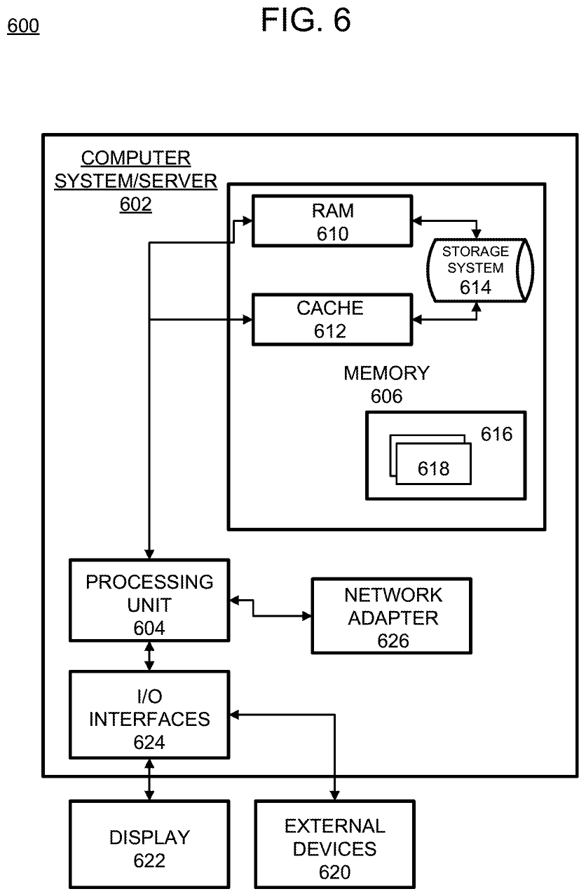

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 6 illustrates an example computer system architecture 600, which may represent or be integrated in any of the above-described components, et

FIG. 6 illustrates an example system 600 that supports one or more of the example embodiments described and/or depicted herein. The system 600 comprises a computer system/server 602, which is operational with numerous other general purpose or special purpose computing system environments or configurations. Examples of well-known computing systems, environments, and/or configurations that may be suitable for use with computer system/server 602 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 602 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 602 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 602 in the system 600 is shown in the form of a general-purpose computing device. The components of computer system/server 602 may include, but are not limited to, one or more processors or processing units 604, a system memory 606, and a bus that couples various system components including system memory 606 to processor 604.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 602 typically includes a variety of computer system readable media. Such media may be any available media that is accessible by computer system/server 602, and it includes both volatile and non-volatile media, removable and non-removable media. System memory 606, in one embodiment, implements the flow diagrams of the other figures. The system memory 606 can include computer system readable media in the form of volatile memory, such as random-access memory (RAM) 610 and/or cache memory 612. Computer system/server 602 may further include other removable/non-removable, volatile/non-volatile computer system storage media. By way of example only, storage system 614 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 606 may include at least one program product having a set (e.g., at least one) of program modules that are configured to carry out the functions of various embodiments of the application.

Program/utility 616, having a set (at least one) of program modules 618, may be stored in memory 606 by way of example, and not limitation, as well as an operating system, one or more application programs, other program modules, and program data. Each of the operating system, one or more application programs, other program modules, and program data or some combination thereof, may include an implementation of a networking environment. Program modules 618 generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 602 may also communicate with one or more external devices 620 such as a keyboard, a pointing device, a display 622, etc.; one or more devices that enable a user to interact with computer system/server 602; and/or any devices (e.g., network card, modem, etc.) that enable computer system/server 602 to communicate with one or more other computing devices. Such communication can occur via I/O interfaces 624. Still yet, computer system/server 602 can communicate with one or more networks such as a local area network (LAN), a general wide area network (WAN), and/or a public network (e.g., the Internet) via network adapter 626. As depicted, network adapter 626 communicates with the other components of computer system/server 602 via a bus. It should be understood that although not shown, other hardware and/or software components could be used in conjunction with computer system/server 602. Examples, include, but are not limited to: microcode, device drivers, redundant processing units, external disk drive arrays, RAID systems, tape drives, and data archival storage systems, etc.

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. An apparatus comprising:
a processor configured to
identify, via a hybrid environment, components which are included in a software program within the hybrid environment;
generate a software bill of materials (SBOM) for the software program which comprises names of the identified components;
detect that the software program does not comply with a predefined policy based on the names of the identified components within the SBOM; and
display a notification via a user interface based on the detection.

2. The apparatus of claim 1, wherein the processor is configured to determine to update the components within the software program based on the detection that the software program does not comply with the predefined policy, and in response, install one or more software updates to the software program within the hybrid environment.

3. The apparatus of claim 1, wherein the processor is further configured to install an agent within the hybrid environment, and collect the components from the software program within the hybrid environment via the agent.

4. The apparatus of claim 1, wherein the processor is further configured to receive an update message from the hybrid environment with an update to the components within the software program in the hybrid environment, and in response, modify the SBOM based on the update to the components.

5. The apparatus of claim 4, wherein the update message comprises a differential between the update the components and a most recent update of the components.

6. The apparatus of claim 1, wherein the SBOM comprises an author name, a supplier name, one or more component names, version information, and one or more component hashes.

7. The apparatus of claim 1, wherein the processor is further configured to identify requirements of the software program from a file and compare the identified requirements of the software program to the SBOM to detect that the software program does not comply with the predefined policy.

8. The apparatus of claim 1, wherein the processor is further configured to determine one or more software libraries to install in the hybrid environment based on the detection that the software program does not comply with the predefined policy, and display identifiers of the one or more software libraries via the notification.

9. The apparatus of claim 8, wherein the one or more software libraries comprise a log 4j software library.

10. A method comprising:
identifying, via a hybrid environment, components which are included in a software program within the hybrid environment;
generating a software bill of materials (SBOM) for the software program which comprises names of the identified components;
detecting that the software program does not comply with a predefined policy based on the names of the identified components within the SBOM; and
displaying a notification via a user interface based on the detection.

11. The method of claim 10, wherein the method further comprises determining to update the components within the software program based on the detection that the software program does not comply with the predefined policy, and in response, installing one or more software updates to the software program within the hybrid environment.

12. The method of claim 10, wherein the method further comprises installing an agent within the hybrid environment, and collecting the components from the software program within the hybrid environment via the agent.

13. The method of claim 10, wherein the method further comprises receiving an update message from the hybrid environment with an update to the components within the software program in the hybrid environment, and in response, modifying the SBOM based on the update to the components.

14. The method of claim 13, wherein the update message comprises a differential between the update the components and a most recent update of the components.

15. The method of claim 10, wherein the SBOM comprises an author name, a supplier name, one or more component names, version information, and one or more component hashes.

16. The method of claim 10, wherein the detecting further comprises identifying requirements of the software program from a file and comparing the identified requirements of the software program to the SBOM to detect that the software program does not comply with the predefined policy.

17. The method of claim 10, wherein the method further comprises determining one or more software libraries to install in the hybrid environment based on the detection that the software program does not comply with the predefined policy, and displaying identifiers of the one or more software libraries via the notification.

18. The method of claim 17, wherein the one or more software libraries comprise a log 4j software library.

19. A computer-readable storage medium comprising instructions, that when read by a processor, cause the processor to perform a method comprising:
identifying, via a hybrid environment, components which are included in a software program within the hybrid environment;
generating a software bill of materials (SBOM) for the software program which comprises names of the identified components;
detecting that the software program does not comply with a predefined policy based on the names of the identified components within the SBOM; and
displaying a notification via a user interface based on the detection.

20. The computer-readable storage medium of claim 19, wherein the method further comprises determining to update the components within the software program based on the detection that the software program does not comply with the predefined policy, and in response, installing one or more software updates to the software program within the hybrid environment.
